(19) United States
(12) Patent Application Publication
(10) Pub. No.: US 2007/0282682 A1
(43) Pub. Date: Dec. 6, 2007

(54) Method for metered advertising based on face time

(76) Inventors: Paul Dietz, Hopkinton, MA (US); Kent Wittenburg, Lynnfield, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/445,788

(22) Filed: Jun. 2, 2006

(51) Int. Cl. G06Q 30/00

(52) U.S. Cl. 705/14

(57) ABSTRACT

A method determines an amount of time consumers are viewing an advertising display. A sequence of images is acquired by a camera of a scene in front of an advertising display. Faces are detected in the sequence of images. For each detected face, determine an orientation of the face with respect to the advertising display and an amount of time each face is oriented towards the advertising display. The times for each of the faces are summed to determine a total face time.

### FIELD OF THE INVENTION

This invention relates generally to advertising systems, and more particularly to a pricing method for advertising systems.

### BACKGROUND OF THE INVENTION

In most cases, the price of advertising is closely linked to the number of people that experience the advertisement. For example, newspaper and magazine advertisers pay according to circulation, and web advertisers typically pay a per viewer fee. That technology easily supports metered advertising.

For television advertising, the situation is somewhat different. In general, a broadcaster does not know in advance precisely how many viewers will see a particular advertisement. So extensive efforts are made to predict the probable number of viewers, and pricing is set accordingly. It is not unusual to guarantee a minimum audience size, and if this is not achieved, the advertisement is rerun until the requisite number is reached. The number of viewers is typically determined by an independent auditing firm that uses statistical sampling techniques. Unfortunately, those techniques at best provide an estimate of the audience size, the actual size is never known.

For large advertising displays, the situation is even more poorly defined. While advertising rates for advertising display are typically driven by estimates of traffic in an area, be it pedestrian or automotive, the large number of signs makes it impractical perform a detailed statistical studies on the number of viewers for each particular sign. Thus, advertisers have been forced to accept a pricing model that very poorly estimates the number of viewers.

This problem is even more difficult when the advertising display is changing or varying over time, and the audience is constantly changing.

### SUMMARY OF THE INVENTION

The embodiments of the present invention provide a business system and method for metering advertising based on an amount of time viewers face an advertising display. In a preferred embodiment, the advertising display uses a display screen or billboard that can display different advertisements over time.

The method uses computer vision techniques to count the number of faces in an image that are viewing the advertising display. The system includes a camera arranged to view a scene in front of the adverting display. By summing the time each face appears in images acquired by the camera ‘face time’, the method can keep track of the ‘total face time,’ i.e., the total amount of time the display was looked at. This allows advertising to be sold by the amount of total face time.

### BRIEF DESCRIPTION OF THE DRAWINGS

FIG. 1 is a schematic of a system for metering face time and total face time according to an embodiment of the invention;

FIG. 2 is a flow diagram of a method for metering face time and total face time according to an embodiment of the invention.

### DETAILED DESCRIPTION OF THE PREFERRED EMBODIMENT

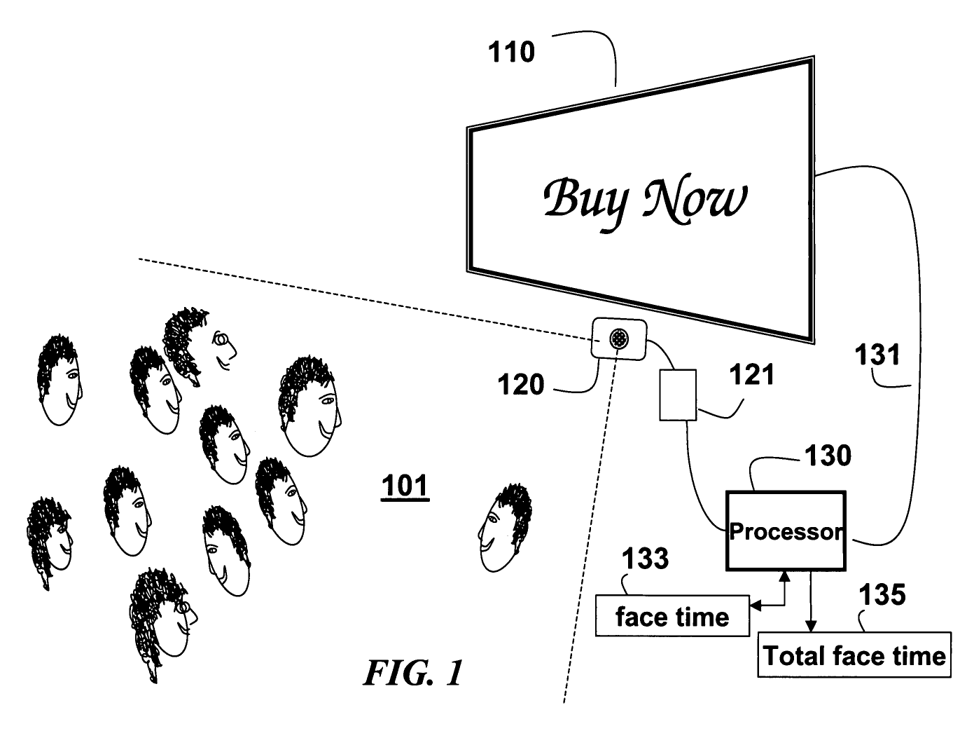

FIG. 1 shows a system for metering ‘face time’ 133 and ‘total face time’ 135 according to an embodiment of our invention. The system includes an advertising display 110, a camera 120 and a processor 130.

In a preferred embodiment, advertising display 110 can change over time. For example, the display is a billboard with vertically rotating members as known in the art, see U.S. Pat. No. 5,572,816, “Rotating advertising sign with rotating louvers,” issued to Anderson on Nov. 12, 1996, incorporated herein by reference. Alternatively, the display uses one or more television screens, or rear projection, or a large scale liquid crystal display (LCD) screen. In any case, the processor 130 can determine, via a connection 131, which advertisement is being displayed at any time, and for how long. It is possible that the advertising schedule is downloaded to the processor ahead of time, or after the fact when face time is being determined, as described herein.

It is also possible that the advertising display 110 is dynamically updated by the processor 130 depending on demographics of consumers in the scene, as described in greater detail below.

The camera 120 is arranged to view a scene 101, for example, a sidewalk outside a store, spectators in a stadium, or an arcade inside a shopping mall. The camera acquires periodically images 121 of the scene. For example, the camera is a video camera and acquires images at a rate of thirty frames per second. Other frame rates can also be used. It should also be noted that the camera can be a pan-tilt-zoom camera to acquire more detailed images of the scene 101.

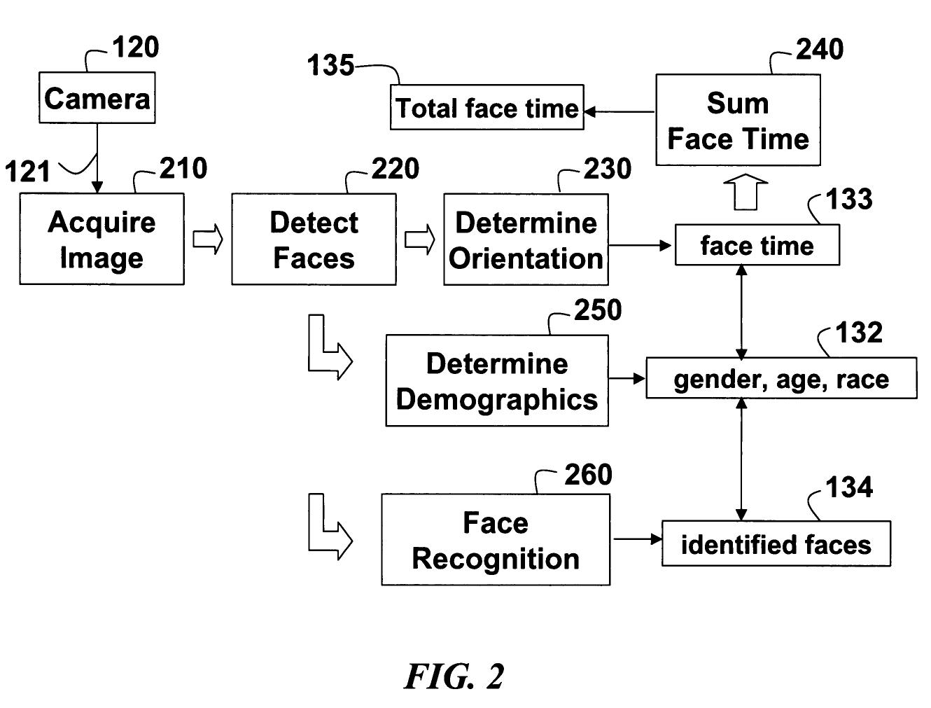

As shown in FIG. 2, the images 121 are acquired 210 from the camera 120. Computer vision techniques are applied to the images. Specifically, face detection 220 is used to locate face, see U.S. Pat. No. 7,020,337, “System and Method for Detecting Objects in Images,” issued to Viola et al. on Mar. 28, 2006, incorporated herein by reference. Once the faces are located, orientations of the faces can be determined 230 with respect to the advertising display 110, see U.S. patent application Ser. No. 10/463,726, “Detecting Arbitrarily Oriented Objects in Images,” filed by Jones et al. on Jun. 17, 2003, incorporated herein by reference. If necessary, pedestrian recognition techniques can be used to first detect and localize consumers, and then to focus on one or more particular faces, see U.S. patent application Ser. No. 10/463,800, “Detecting Pedestrians Using Patterns of Motion and Appearance in Videos,” filed by Viola et al. on Jun. 17, 2003, incorporated herein by reference.

By tracking the faces in a sequence of images, it is possible to measure and sum 240 the amount of time 133 each face is oriented at the display to obtain the total face time 135. The time can be determined by counting the number of frames in which each face appeared. This enables advertising to be sold by the total face time 135. It is also possible to threshold the time for each face so that only casual glances at the display are not considered.

It should be noted, that other known face-based computer vision techniques can also be applied to determine demographics 250 of the faces, such as gender, age, and race. The demographics can be correlated 132 with the face time 133.

It is also possible to perform face recognition 260 to perform long term tracking of identified faces 134, see U.S. Pat. No. 7,031,499, “Object Recognition System,” issued to Viola et al. on Apr. 18, 2006, incorporated herein by reference. It should be noted, that all of these computer vision techniques can use the same so robust ‘Viola-Jones’ rectangular filtering procedure, greatly simplifying the processing.

Metering face time and demographics enables new business methods. These include the following.

An advertisement is displayed for a predetermined amount of time, but the fee depends upon the actual face time hours for the advertisement.

The advertiser pays for a predetermined amount of face time, and the advertisement is displayed until this amount is reached. It should be noted that an advertisement can be displayed intermittently with other advertisements. The advertising schedule can then correlate face times with particular advertisements.

An advertiser is guaranteed a predetermined amount of face time for a certain time interval. If the face time is not met, an accommodation is made, such as running the advertisement longer, or rebating part of the fee.

Advertisers may desire an independent verification of the face time data. An auditing service can provide the equipment, and determines face time statistics. The statistics can be provided in real-time to help determine specific advertisements to display.

As described above, computer vision techniques can be used extract demographic information in real-time from the images. This enables advertising pricing to be determined by face time for particular demographic groups.

In addition to demographic information, the system can also recognize other object features of interest to advertisers. For example, a laser eye surgery service may wish to target consumers wearing glasses, and the system could be configured to track face time of just this group of consumers.

For changeable displays, the display typically switches among different advertisers. If the pricing is based on face time of particular groups, then it is desirable to change advertisement are being shown and for how long dependent upon demographics of current viewers so as to maximize the value of the displayed advertisements.

The embodiments can be combined with other known processes. For example, face time pricing can be weighted by the number of unique consumers. These variations are within the scope of the current invention.

It is also possible to place one or more cameras at locations. Despite different viewpoint, it is still possible to determine which faces are oriented towards the advertising display 110.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for determining an amount of time consumers are viewing an advertising display, comprising:
acquiring a sequence of images of a scene in front of an advertising display with a camera;
detecting faces in the sequence of images;
determining, for each detected face, an orientation of the face with respect to the advertising display;
measuring, for each face, an amount of time each face is oriented towards the advertising display; and
summing the times for each of the faces to determine a total face time.

2. The method of claim 1, further comprising:
displaying different advertisement on the advertising display over time; and
determining the total face time for each advertisement.

3. The method of claim 1, further comprising:
determining, for each face, demographics.

4. The method of claim 3, further comprising:
displaying different advertisements on the advertising display according to the demographics.

5. The method of claim 1, in which detailed images of the faces located in the sequence of images are acquired.

6. The method of claim 1, further comprising:
recognizing the faces in the sequences of frames.

7. The method of claim 1, in which an advertisement is displayed for a predetermined amount of time, and a fee depends upon the total face time for the advertisement.

8. The method of claim 1, in which an advertiser pays for a predetermined amount of face time, and an advertisement is displayed until the predetermined amount of face time is reached.

9. The method of claim 1, in which an advertiser is guaranteed a predetermined amount of the total face time for a certain advertisement time interval, and if the predetermined amount of the total face time is not met, the advertisement time interval is extended.

10. The method of claim 1, in which an advertising fee is dependent on the total face time.

11. The method of claim 3, in which the advertising fee is dependent on the total face time and on the demographics of the faces.

12. The method of claim 1, in which additional objects are recognized in the scene.

13. The method of claim 1, in which advertisements displayed on the advertising display change dynamically, and a value of the displayed advertisements is maximized according the total face time.

14. The method of claim 13, further comprising:
determining, for each face, demographics; and
maximizing a value of the displayed advertisements according the demographics of the face.

15. The method of claim 1, in which the summing only includes times of each face that are larger than a threshold.

16. A system for determining an amount of time consumers are viewing an advertising display, comprising:
an advertising display;
a camera configured to acquire a sequence of images of a scene in front of the advertising display;
a face detector configured detect faces in the sequence of images and an orientation of each detected face with respect to the advertising display;
means for measuring, for each face, an amount of time each face is oriented towards the advertising display to determine a face time; and
means for summing the face times for each of the faces to determine a total face time.
